(19) United States
(12) Patent Application Publication
(10) Pub. No.: US 2011/0319059 A1
(43) Pub. Date: Dec. 29, 2011

(54) CELLULAR PHONE WITH COURSING LOGOS

(76) Inventor: Dov PADEH, New York, NY (US)

(21) Appl. No.: 13/167,051

(22) Filed: Jun. 23, 2011

Related U.S. Application Data
(60) Provisional application No. 61/357,599, filed on Jun. 23, 2010.

(51) Int. Cl. H04W 4/00; H04M 1/02

(52) U.S. Cl. 455/414.1; 455/566

(57) ABSTRACT

A telephone device which comprises a housing, a display screen, and internal processor for displaying telephone related symbols and information alongside advertising copy. The telephone device includes the basic wireless communication system for communicating wirelessly with telephone base stations. To display the advertising copy, the invention comprises an advertising processor that includes software modules configured to receive advertising information in the form of distinctly rendered and placed text and/or logos and to locate and display the advertising information on the display in an manner which does not interfere with the reading of the telephone information on the display screen.

### CROSS-REFERENCE TO RELATED APPLICATION

The present application claims the benefit of U.S. Provisional Patent Application No. 61/357,599 filed on Jun. 23, 2010, which is incorporated herein by reference in its entirety

### BACKGROUND OF THE INVENTION

The present invention relates to a telephone and, more specifically, to a telephone containing a display screen with advertising logos displayed in a standstill and/or moving modes, on the telephone screen.

### SUMMARY OF THE INVENTION

Accordingly, it is an object of the present invention to provide a telephone or similar communication device that contains a display screen with constant advertising logos displayed in standstill or moving modes.

It is another object of the present invention to provide sponsored links to business vendors.

It is yet another object of the invention to provide a system that facilitates advertising to customers which carry telephone and similar communication devices.

The foregoing and other objects of the invention are realized with a telephonic and/or communication device that contains a display screen and which is configured to display advertising logos that can be displayed in a standstill mode and/or in various moving modes.

In accordance with an embodiment of the invention, the advertising logos or messages are configured to be activated by a touch of a finger or a stylus to initiate communications with a corresponding business entity.

### BRIEF DESCRIPTION OF THE DRAWINGS

FIG. 1 displays a telephone device with a first logo displayed thereon.

FIG. 2 displays a telephone with a second advertising logo displayed thereon.

FIG. 3 shows a conventional telephone device with various logos displays thereon in accordance with the invention.

FIG. 4 shows yet another embodiment of the invention.

FIG. 5 shows a back side of a telephone which is decorated and printed with logos for additional advertising coverage.

FIG. 6 illustrates a telephone which is responsive to a user's gaze or touch.

FIG. 7 shows a phone with a slogan displayed during turn on.

FIG. 8 is a system block diagram of the invention.

Other features and advantages of the present invention will become apparent from the following description of the invention which refers to the accompanying drawings.

### DETAILED DESCRIPTION OF EMBODIMENTS

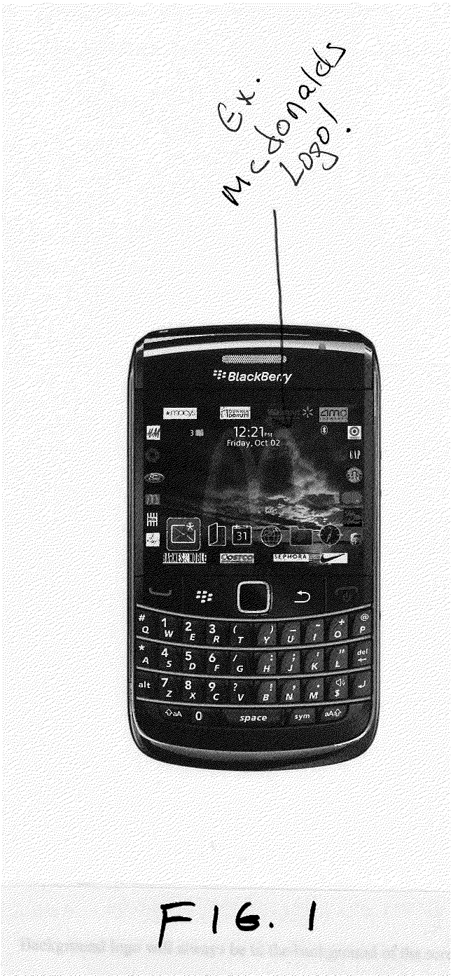

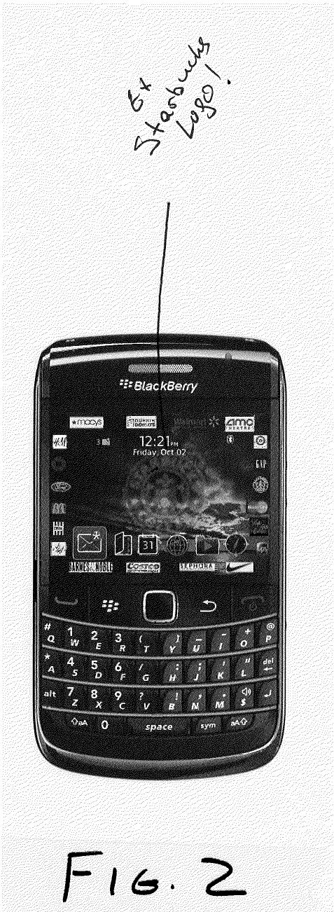

As shown in the attached drawings, the depicted phone has a background logo which remains in the background of the screensaver. The background logo can change from time to time. For example, in FIG. 1, it is the familiar McDonald's logo, whereas in FIG. 2, it is the Starbucks logo.

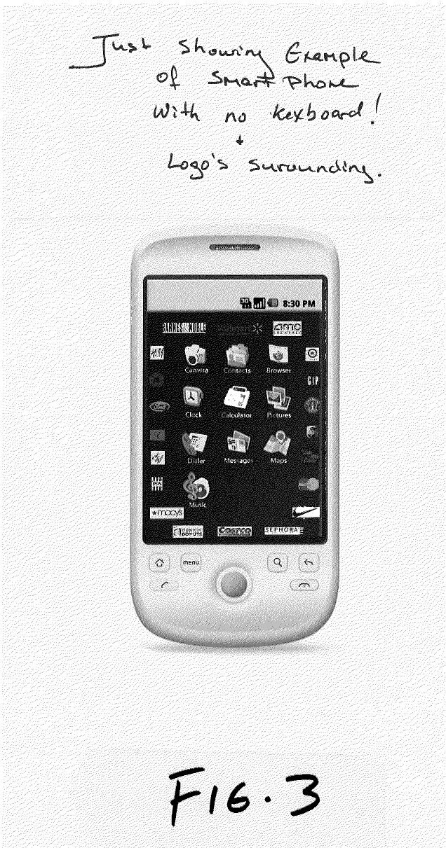

In addition to, or independently of the foregoing screensaver depiction of a logo, a plurality of logo or trademark blocks can be displayed along the periphery of the telephone, as shown in FIG. 3. For example, along the bottom of the phone, one can discern from left to right, the ★Macy's logo, the Dunkin' Donuts logo, the Costco logo, the Sephora logo and the familiar Nike ✓ logo. See also, the logos at the top of the screen.

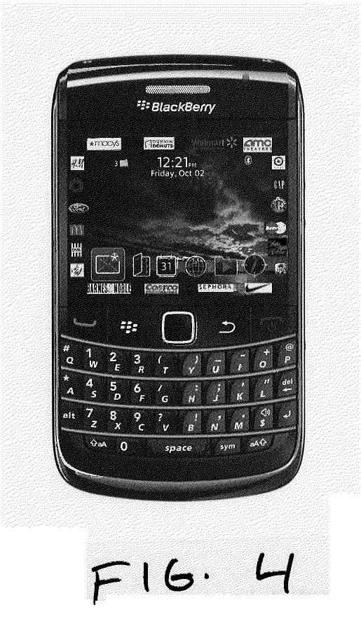

With reference to FIG. 4, the logos will typically be moving around the screen along the border, and/or may at times remain still. When someone clicks on the logo, the software application will recognize which logo has been touched and the business entity owning that logo can call up the phone owner to determine if they need any assistance or information, or they may forward a telephone or an e-mail message. In addition, on a daily, weekly, or periodic basis, when a particular logo is being advertised on the phone, the particular logo may be associated with some sort of a coupon for that day, if that logo is touched by the user.

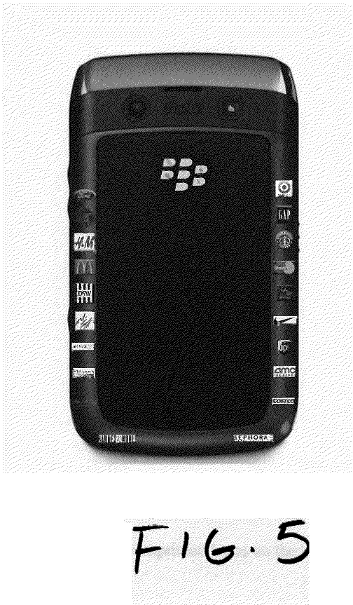

As illustrated in FIG. 5, the back (or even the front housing portion) of the phone can be decorated or imprinted with logos for additional advertising usage of the handheld phone device.

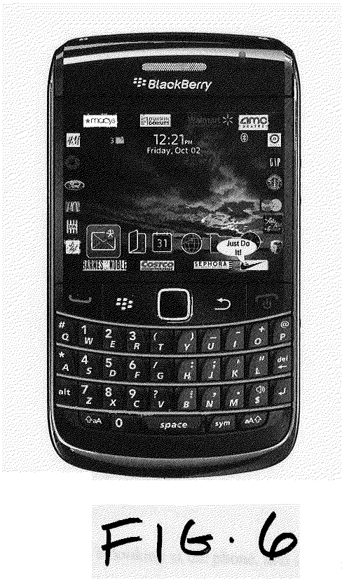

With reference to FIG. 6, either by noting the gaze of user or by the phone being simply held in one's hand, the phone will recognize that someone is looking at the phone and slogans will pop out from the different logos.

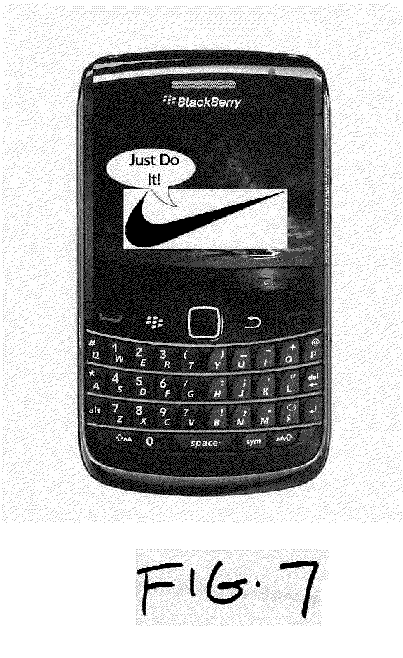

With reference to FIG. 7, when the phone is being turned on and off, slogans and logos will pop out in the middle of the screen to catch the final or initial attention of the phone user before actual use of the phone is made.

It is within the ambit and scope of the invention to move the logos around, so that they never obstruct substantive subject matter or content that needs to be displayed on the telephone.

Lastly, for applications on the telephone that configure the telephone as a GPS device, the invention contemplates that the written instructions will use the phrase ““logo” [e.g., Nike] says turn right” or ““logo” says turn left in a hundred feet”, and the like. This can be either an audible message where, for example, one can hear the sound of “Nike says”, or it can be visual or a combination thereof

In accordance with a further embodiment, the different logos or ads coursing around the display screen of the telephone are provided from and are associated with different business entities. To encourage advertiser participation and user interest in the advertising information, the invention is configured such that the local processor or an offboard processor communicate to the telephone server providing the duration, frequency and nature of user interest in these logos and generates a credit against monthly telephone charges or awards reward points for exhibiting interest in the advertising information.

Thus, a user and subscriber who regularly clicks on and/or receives information from advertising entities, is awarded either direct credit for the incurred, monthly telephone charges and/or reward points that can be redeemed. This feature of the invention has the effect of promoting advertiser participation in the system of the present invention and also encourages telephone service providers to participate because it will reduce the telephone chargers to users and increase the subscriber base to the participating telephone service providers.

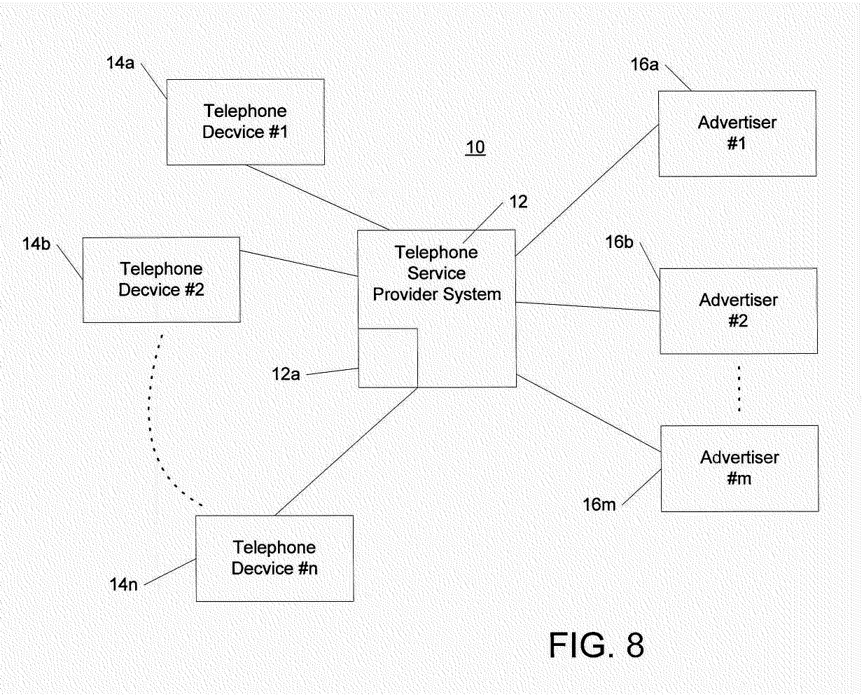

With reference to FIG. 8, the overall inventive system 10 comprises a telephone software provider system 12, which designates a typical telephone service provider, such as Verizon, T-Mobile, Sprint and the like.

A large number of telephone devices 14a, 14b . . . 14n are connected to the system and communicate therewith, in well known manner. The individual devices previously discussed display telephone information and the advertising copy. The advertising copy or information is provided from advertisers such as advertiser 16a, 16b . . . 16m.

Each of the telephone devices 14a, 14b . . . 14n has, in well known manner, a telephone housing, a display screen, as well as an internal processor for displaying telephone related symbols and information. In well known manner, these telephones have a wireless communication subsystem for communicating data from and to the telephone, wirelessly. In accordance with the present invention, each of these devices also has its internal processor, including an advertising processor comprising software modules configured to receive advertising information, in the form of distinctly rendered and distinctly placed text and/or logos, and to locate and display said advertising information on said display screen in a manner that constantly monitors the locations of said advertising information on said display screen and adjusts said locations to avoid blocking or interfering with the viewing of the telephone information.

In accordance with the present invention, the telephone service provider system 12 comprises internal processors and software modules annotated collectively with reference numeral 12a which are responsible for tracking and logging information about the duration, nature and level of user interaction with the various logos and advertising information appearing on their telephone devices and also generating rewards which comprise reduced telephone charges and/or other rewards and which thus encourage usage of the system of the present invention.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A telephone device, comprising:
a telephone housing;
a display screen;
an internal processor for displaying telephone related symbols and information;
a wireless communication subsystem for communicating data from and to the telephone wirelessly;
the internal processor including an advertising processor comprising software modules configured to receive advertising information in the form of distinctly rendered and distinctly placed text and/or logos and to locate and display said advertising information on said display screen in a manner that constantly monitors the locations of said advertising information on said display screen and adjusts said locations to avoid blocking or interfering with the viewing of the telephone information.

2. The telephone device of claim 1, wherein said display screen comprises a surrounding border region and said advertising processor is configured to move around said advertising information along said border region.

3. The telephone device of claim 1, wherein said advertising processor comprises a facility that is configured to recognize which logos have been touched and to communicate messages to business entities associated with said logos that have been touched.

4. The telephone device of claim 3, wherein said advertising processor is further configured to forward telephone and/or e-mail messages from and to said business entities.

5. The telephone device of claim 3, wherein said advertising processor further comprises a facility that associates a particular logo with a reward which is provided to a user if he or she touches a particular logo at a particular time.

6. The telephone device of claim 1, wherein said housing comprises a back side and at least one advertising message displayed on said back side.

7. The telephone device of claim 1, wherein said advertising processor is configured to display said advertising information at the time when the telephone device is turned on.

8. The telephone device of claim 1, wherein said telephone device comprises a facility that renders said advertising information in a gray scale that allows it to appear below telephone information, without impairing the ability to convey to a user the telephone information.

9. The telephone device of claim 1, wherein said telephone device provides a communication device that contains a display screen with constant advertising logos displayed in standstill or moving modes.

10. The telephone device of claim 1, wherein said telephone device is configured to provide sponsored links to business vendors.

11. The telephone device of claim 1, wherein said telephone device provides a system that facilitates advertising to customers which carry telephone and similar communication devices.

12. The telephone device of claim 1, wherein said telephone device contains a telephonic and/or communication device that contains a display screen and which is configured to display advertising logos that can be displayed in a standstill mode and/or in various moving modes.

13. The telephone device of claim 1, wherein the advertising logos or messages are configured to be activated by a touch of a finger or a stylus to initiate communications with a corresponding business entity.
